(19) United States
(12) Patent Application Publication
(10) Pub. No.: US 2002/0026330 A1
(43) Pub. Date: Feb. 28, 2002

(54) System and method for patient medication management and compliance using a portable computing device

(76) Inventor: Edward E. Klein, Chappaqua, NY (US)

Correspondence Address: Eugene C. Rzucidlo, GREENBERG TRAURIG, LLP, 21st Floor, 885 Third Avenue, New York, NY, 10022-4834, US

(21) Appl. No.: 09/808,842

(22) Filed: Mar. 15, 2001

Related U.S. Application Data
(63) Continuation-in-part of application No. 09/644,878, filed on Aug. 23, 2000.

(51) Int. Cl. G06F 17/60

(52) U.S. Cl. 705/3; 705/2

(57) ABSTRACT

The present invention relates to a system and method to manage the administration of medication to a patient. In particular, the system and method of the present invention maintains a database of medications to be taken by a patient. The database includes at least the medication name, dosage, and administration time or frequency of administration. In addition, the database may contain specific cautionary warnings and notices regarding the administration of the medication. The system and method monitors the medication schedule to determine the time that a particular medication should be administered. Once an administration time has been determined, a notification is provided to a patient or caregiver at the appropriate time indicating the particular medication to administer. The system and method then determines the identity of a medication chosen by the patient or caregiver to be administered, and compares this medication to the medication identified in the medication schedule. The system and method then determines whether the correct medication has been chosen by the patient or caregiver for administration, and reports the results.

### CROSS-REFERENCE TO RELATED APPLICATION

This application is a continuation in part of U.S. application, Ser. No. 09/644,878 filed Aug. 23, 2000, entitled SYSTEM AND METHOD FOR PATIENT MEDICATION MANAGEMENT AND COMPLIANCE”, currently pending (attorney docket number 35858.11).

### FIELD OF THE INVENTION

The present invention relates to a system and method to manage the administration of medications to a patient. In particular, the system and method of the present invention maintains a database of prescribed medications to be taken by a patient. The database includes at least the medication name, dosage, and administration time or frequency of administration. In addition, database may contain specific cautionary warnings and notices regarding the administration of the medication. A notification is made by a medication management unit to an individual administering medication that a medication should be taken. Once the notification is received, the administrating individual scans a tag on the medication container with the medication management device. The medication management device then determines whether the patient has scanned the correct medication, and provides a report to the administrating individual.

### BACKGROUND OF THE INVENTION

The number of Americans age 65 or older increased tenfold in the last century, and the elderly are living longer, in more comfort and in better health that ever before. There are approximately 35 million people in the United States age 65 or older, accounting for approximately 13 percent of the population. By contract, in 1900 the number of Americans over 65 was about 3.1 million.

While some increase in America's senior population can be attributed to the aging of baby boomers, a significant portion of this increase can be attributed to a rise in the average American's longevity. On average, the life expectancy for a 65 year old American in the year 1900 was 2 years. Today, in the year 2000, a 65 year old American could expect to live an additional 18 years.

Similarly, the average life span of a person living in American has grown steadily over the last century. For example, in 1968 the average life span of person living in the United States was 70.2 years. By the year 1998, this number had grown by approximately 9 percent to 76.5 years.

There are many factors that can be attributed to this increase in longevity, including breakthroughs in medical technologies and diagnostics. In addition, it is universally recognized that the development of new medications has permitted successful treatment of numerous medical conditions representing an important factor in this dramatic increase. However, commensurate with these breakthroughs in medical pharmacology has come an increase in activity in the health care system caused by drug interactions or patient non-compliance in prescription drug self-administration.

Non-compliance in prescription drug taking has put an enormous strain on the entire health care system. It is estimated that costs to the United States economy associated with prescription drug non-compliance range from 50 to as high as 100 billion dollars per year. In addition, it is estimated that at least 17 percent of all Emergency Room visits are the direct result of prescription drug non-compliance. Other results of non-compliance include hospital and nursing home admissions, as well as lost wages and lower productivity. See U.S. Pat. No. 5,963,136 issued to O'Brian for a detailed description of the economical ramifications of prescription drug non-compliance.

Drug interaction, and specifically prescription drug interaction, has been and is a problem throughout the world. Surveys indicate that three to five percent of all hospital admissions are the result of adverse drug reactions, accounting for 30,000 deaths and 1.5 million hospital admissions per year. Conservatively, the cost of these hospital admissions exceeds $1 billion annually.

Problems associated with self-administration of prescription drugs are directly related to the number and frequency of doses of medication taken. Inability to take drugs in accordance with prescribed routines may not only limit the effectiveness of the medication, but may in fact substantially increase drug reactions.

Dosage instructions are typically printed on medication bottles. However, there are many medications, which often require complex dosage schedules having administration levels, routines and instructions that may change each specific time the drug is administered. Although many physicians will provide the patient with a written dosage schedule, patient's frequently forget to use their medications as prescribed, or confuse the frequency which their medications are to be used. See U.S. Pat. No. 5,347,453 issued to Maestre for a detailed description of problems associated with patient compliance to dosage schedules.

The elderly, visually impaired and handicapped are especially prone to problems associated with improper self-administration of prescription medication. In most instances the patient's handicap or infirmity make it challenging to follow their doctor's instructions for taking the medication. The consequence of not properly taking the medication can be exacerbated by the fact that the elderly or infirm are likely taking multiple prescription medications, which can interact adversely when not properly taken. In addition, the level of physical infirmity in these patients reduces their ability to withstand the effects of improperly taking the medication. See U.S. Pat. No. 5,088,056 issued to McIntosh et al. for a detailed description of drug interaction problems associated with the self-administration of prescription medication.

What is needed is a system and method to provide individualized affirmative notification to a patient to take a prescription medication in accordance with a defined medication schedule.

What is further needed is a system and method to provide individualized schedule and dosage instructions to a patient taking a prescription medication.

What is further needed is a system and method to ascertain the identity of particular prescription medication prior to the patient self-administering the drug, and to provide positive feedback to the patient identifying the correct medication to administer.

What is further needed is a system and method to allow a physician to monitor a patient's compliance with a prescribed medication regime.

### SUMMARY OF THE INVENTION

An object of the present invention is to provide a system for an individual to manage the administration of a medication. The individual administering the medication to the patient may be the patient him or herself, or a caregiver. To accomplish this, the present system comprises an identification tag, for identifying the medication selected by a patient or caregiver to be administered, and a medication management unit.

The medication management unit is capable of monitoring a medication schedule to determine the time the medication should be administered to the patient. Once an administration time is determined, the medication management unit provides a notification to administer the medication at the appropriate time. The medication management unit also comprises a medication indicator for indicating the identity of the medication to be administered.

The individual administering the medication to the patient then selects the medication to administer. Once a medication has been selected, an input/out device operatively connected to the medication management unit reads the identification of the medication. The medication management unit compares the identity of the selected medication to the identity of the medication indicted by the medication schedule, and determines if the correct medication was selected to administer. The medication management unit then displays the results of the comparison to the individual administering the medication.

Another object of the present invention is to provide a method for managing the administration of medication to a patient. To accomplish this, the present method monitors a patient's medication schedule to determine the time the medication should be administered to the patient. Once an administration time has been determined, the method provides a notification to administer the medication at the appropriate time, and indicates the identity of the medication to be administered.

Prior to the administration of medication to the patient, the present method obtains the identity of the medication selected to be administered. A comparison is them made between the identity of the medication selected for administration and the identity of the medication to be administered in accordance with the medication schedule. The results of the comparison are then reported.

### BRIEF DESCRIPTION OF THE DRAWINGS

FIG. 1A and 1B are diagrammatic representations of the system components according to embodiments of the present invention.

FIG. 2 is a diagrammatic representation showing various identification tags to identify the medication vial according to an embodiment of the present invention.

FIG. 3A and 3B are diagrammatic representations showing the interface between a pharmacist's computer system and the medication management unit according to embodiments of the present invention.

FIG. 4A and 4B are diagrammatic representations showing the interaction of the system components according to embodiments of the present invention.

FIG. 5 is an illustrative flow diagram further depicting the steps to activate the medication management unit for use by a patient according to an embodiment of the present invention.

FIG. 6 is an illustrative flow diagram further depicting the steps followed by a patient utilizing the medication management system according to an embodiment of the present invention.

### DETAILED DESCRIPTION OF THE PREFERRED EMBODIMENTS

A system and method for managing the administration of prescribed medications is disclosed. The present invention is primarily intended for use remotely by a patient self-administering prescription medications. However, the system and method may also be used by physicians, medical professionals and caregivers caring for patients either in the patient's home or at a remote facility. For the purpose of illustration, the invention described in the following figures characterizes a medication management system and method for a patient self-administering prescription medications. However, one skilled in the art can appreciate that the present invention may be used in numerous applications where the schedule and dosage of medication needs to be managed.

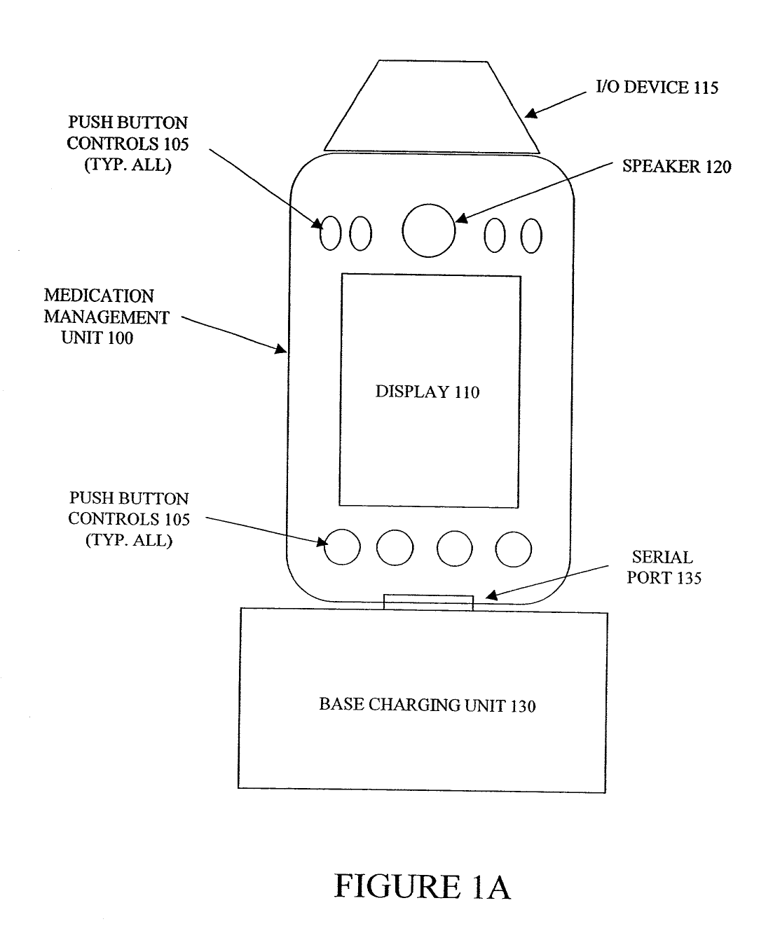

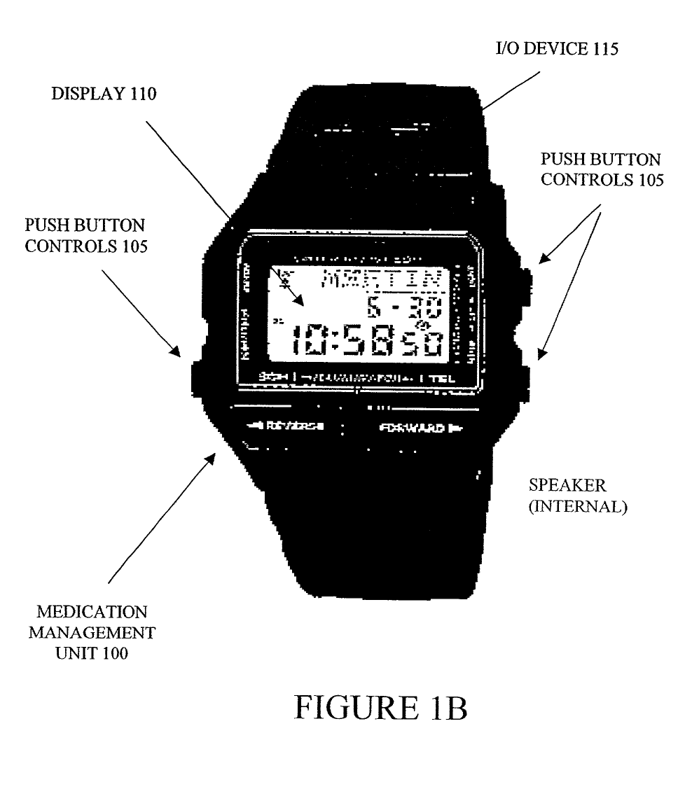

A diagrammatic representation of some system components according to an embodiment of the present invention is shown in FIG. 1A. A critical component of the system is a medication management unit 100. The medication management unit 100 is a microprocessor based device, such as a hand held computer, pocketable computer, or personal digital assistant (PDA) (hereinafter the terms hand held computer, pocketable computer and personal digital assistant or PDA will be used interchangeably). A hand held computer is a computing device that can be easily held in one hand while the other hand is used to operate the device. Palm™ and Pocket PCT™ are popular platforms for hand held computers. These hand held computers support an open architecture for their operating systems. This open architecture allows third-party developers to create a vast variety of software applications for them, including various database and utility programs.

In another embodiment of the invention, the Medication Management Unit 100 may be any other type of portable computing device, such as, for example, a programmable wristwatch or similar device capable of maintaining a database of the patient's medication and identifying the patient's medication through some type of input/output (I/O) device. A diagrammatic representation of one such device according to an embodiment of the present invention is shown in FIG. 1B.

The technology associated with the medication management unit may also assist the patient in establishing a Personal Area Network or PAN. A PAN comprises a transmission technology that lets people transfer information by personal or near personal contact. For example, you could exchange electronic business cards by shaking hands. By touching your pager in one hand, you could send the calling telephone number to your cell phone in the other. A PAN-enabled unit worn on the wrist could transmit a user's ID to all variety of check-in or check-out machines including medical databases, ATMs, security checkpoints, hospital admittance, etc.

Medication management unit 100 comprises the necessary software, hardware and memory (not shown) to read and store a patient's medication schedule and dosage requirements. This may include, for example, a proprietary program and database to maintain, organize and utilize the medication schedule. In addition, the medication management unit 100 is capable of: (i) providing notification to a patient to self-administer medication; (ii) identifying the patient selected medication for self-administration; (iii) and determining whether the patient selected medication is proper for administration. Advance features of the medication management unit 100 may also prompt the patient user to confirm the medication was administered so the event may be recorded for future review and analysis by a treating physician.

The medication management unit 100 monitors the patient's medication schedule and provides notification to the patient when medication is to be administered. A clock internal to the medication management unit 100 monitors the time or time interval between medication administrations. This clock may be part of the medication management unit 100's hardware or software. In one embodiment of the invention, the internal clock measures actual calendar and clock time in real-time. In this embodiment, the medication management unit 100 notifies the patient to administer the medication at particular real-time periods. These times are based on the actual time of day, week, month and year indicated by the medication administration schedule. In another embodiment of the invention, the medication management unit 100 measures the time interval from the time the last medication was actually administered before notifying the patient. In this embodiment, the patient is requested to provide a confirmation to the medication management unit 100 when a scheduled medication is taken. The medication management unit 100 then calculates the next time period the medication should be taken based on the actual prior administration. The use of a hardware or software clock mechanism to provide a notification of a scheduled event is well known in the art.

A patient may provide confirmation that the medication was administered by communicating with medication management unit through various input means. In one embodiment of the invention, the hand held computer is pen based. A patient communicating with the medication management unit 100 uses a stylus to tap selections on menus and to enter printed characters displayed in display 110. Display 110 may be any surface upon which text and graphics may appear, and includes cathode ray tubes (CRT) and flat panel technology. In one embodiment of the invention, display 110 is a high contrast anti-reflective color liquid crystal display (LCD) panel capable of tough or pen based input. The medication management unit 100 may also include a small on-screen keyboard which is tapped with the pen to input characters. In another embodiment of the invention, the display 110 of the medication management unit 100 is a touch-based graphical interface. A patient communicating with the medication management unit 100 may make selections and input information by touching appropriate sections of the display 110 screen. In still a further embodiment of the invention, the medication management unit 100 may have pushbutton controls 105 or a keypad (not shown).

The notification provided by the medication management unit 100 to the patient might be aural, visual, vibratory or any combination of the three. In one embodiment of the invention, the medication management unit 100 provides an audible tone through speaker 120 to notify the patient to administer the medication.

In another embodiment of the invention, the medication management unit 100 provides a visual notification to the patient. The visual notification may be, for example by displaying a colored graphic on the display 110 to inform the patient to administer the medication. This colored graphic may be followed by a textual message on the display 110 indicating that medication should be administered. In still a further embodiment of the invention, the medication management unit 100 vibrates to notify the patient to administer the medication.

As the patient is being notified to administer the medication, the medication management unit 100 simultaneously informs the patient what particular medication and dosage needs to be administered. When the patient is notified to administer the scheduled medication, the medication management unit 100 displays a textual message identifying the medication and exact dosage to be administered on display 110.

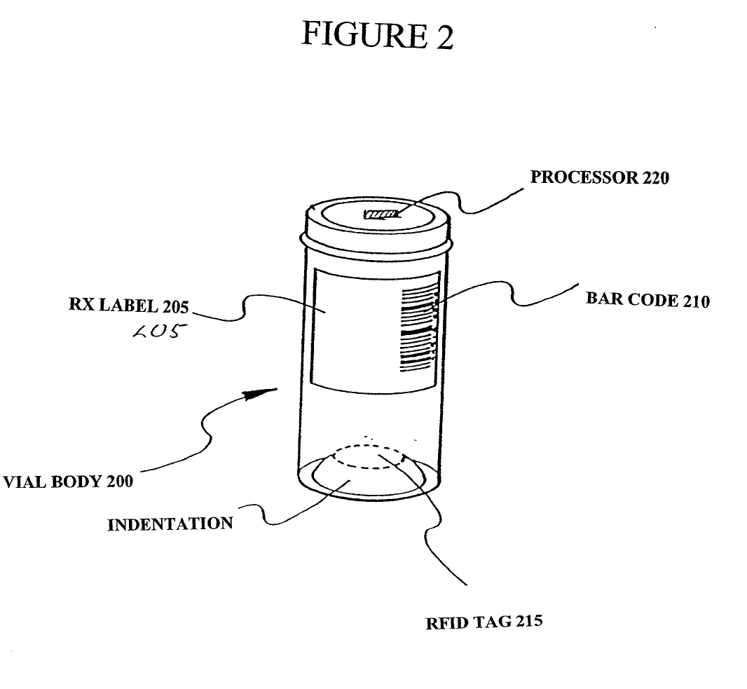

The medication management unit 100 is also capable of identifying the medication that the patient has selected for administration. A diagrammatic representation showing various identification tags used to identify a medication vial according to an embodiment of the present invention is shown in FIG. 2. Although the identification tags are shown in particular locations on the vial, any suitable location may be used. When the pharmacist fills the patient's prescription, RX label 205 is affixed to a medication vial 200 identifying the medication. Typically, these RX labels 205 include text identifying the prescription along with a dosage schedule. In addition, the RX label 205 may include a bar code symbol 210 identifying, in graphical form, the medication and/or dosage being dispensed.

In one embodiment of the invention, the bar code symbol 210 is a one-dimensional bar code label representing the medication being dispensed. In another embodiment of the invention, the bar code symbol 210 is a two dimensional bar code label, such as the PDF417 bar code image developed by Symbol Technologies, the DataMatrix code label, or the MaxiCode label. In addition to providing medication identification, two-dimensional bar codes have the added ability to store a voluminous amount of information on a single bar code image. This may include particular information about the medication as well as instructions for taking the medication.

In addition to bar code technology, other types of data storage and transmission devices may be used to identify the medication being dispensed. These devices rely on wireless storage and transmission methods, such as Radio Frequency Identification (RFID) and/or smart card technology to electronically identify the prescribed medication. In one embodiment of the invention, a Radio Frequency Identification tag (RFID) 215 may be affixed to the medication vial. RFID tag 215 can be encoded with at least the medication identification. In another embodiment of the invention, the medication vial may contain a built in microprocessor and memory 220, similar to those found in smart cards, to identify the medication and provide the administration schedule and/or cautionary warnings. In such applications, the medication management unit 100 may be capable of reading and writing to the memory 220 to store the patient's medication administration routine. A treating physician may retrieve this information at a later period of time to review the patient's compliance with the medication administration schedule. The use of bar code labels, RFID tags and smart card like devices to store identification data are well known in the art.

To facilitate identifying the medication that the patient has selected, medication management unit 100 is equipped with an input/output (I/O) device 115. I/O device 115 can be any type of device capable of exchanging information with the medication identification label or tag.

In one embodiment of the invention, the I/O device 115 is a bar code scanner, such as a visible laser diode (VLD) scanner or infrared transceiver, capable of reading bar codes and converting them into either ASCII or EBCDIC digital character code. In another embodiment of the invention, the I/O device 115 is an RFID reader capable of powering an RFID tag device and reading the information from the RFID tag. In still a further embodiment of the invention, the I/O device 115 is a contactless reader/writer capable of reading information from, and writing information to, contactless microprocessors integrated into the medication vial. The RFID and smart card technology utilize radio frequency signals to communicate between the I/O device 115 and the identification tags.

To allow for portable operation, medication management unit 100 can be battery operated using any one of several different methods. For example, in one embodiment of the invention, medication management unit 100 is equipped with rechargeable batteries, such as lithium ion, nickel cadmium (NI-CAD) or nickel metal hydride. In instances where rechargeable batteries are used, the present system includes base charging unit 130 to restore the charge to the batteries. In addition, charging unit 130 may server the dual purpose of converting typical alternating current found in most homes to low voltage direct current. Units so equipped will allow the medication management unit 100 to operate as a base unit off household alternating current, while charging the batteries for times that the unit will operate in the portable mode.

In addition to operating as a rechargeable unit, the medication management unit 100 can operate as a portable, non-rechargeable unit. Advances in battery technology, such as the development of lithium batteries will allow the medication management unit 100 to operate for extended periods of time without requiring a battery recharge or replacement.

As previously discussed, the medication management unit 100 is a microprocessor based device comprising the necessary hardware, software and memory to store the patient's medication schedule and dosage requirement. A pharmacist filling the patient's prescription programs the medication management unit 100 by downloading this information into a database (not shown) resident in the medication management unit 100. The pharmacist may also read information stored in the database to obtain the patient's electronic prescription or determine what other medications have been previously prescribed to the patient. To perform these functions, an interface and software is provided for the pharmacist's computer system.

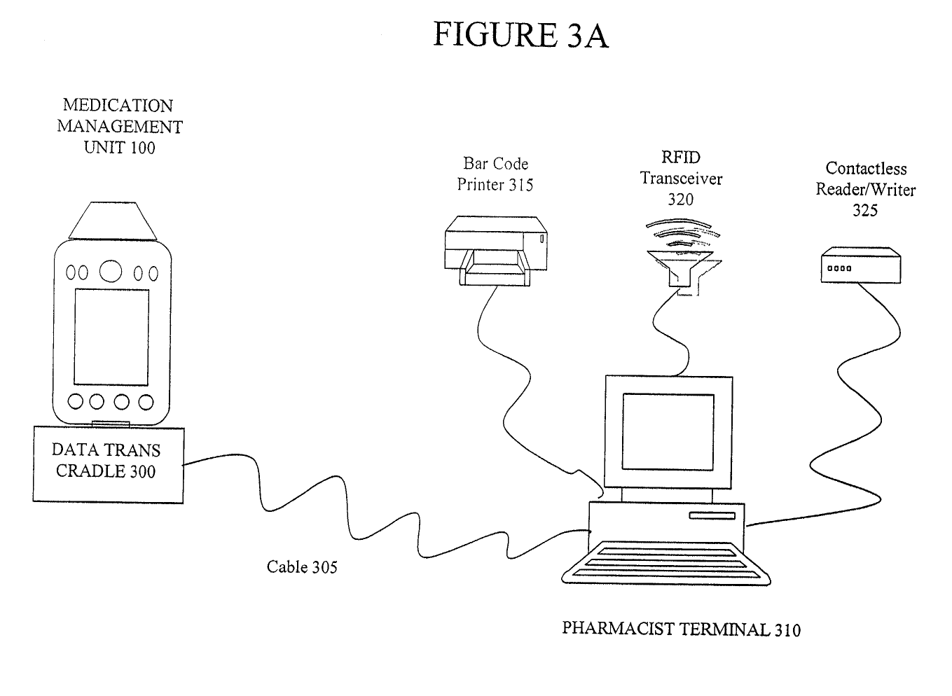

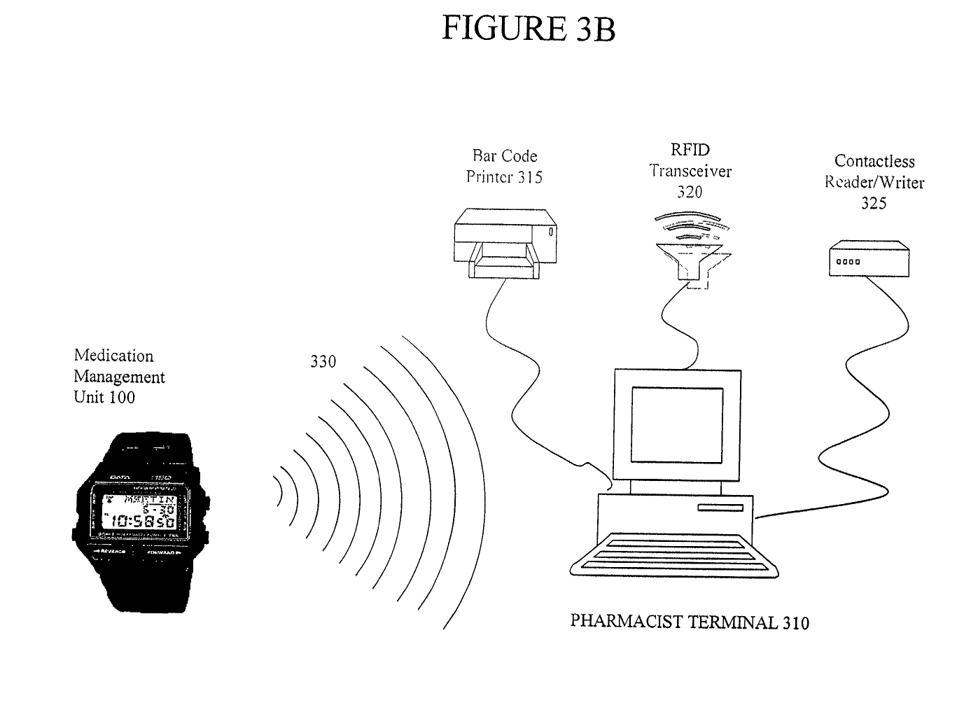

Diagrammatic representations showing the interface between a pharmacist's computer system and the medication management unit according to embodiments of the present invention are shown in FIG. 3A and FIG. 3B.

Turning to FIG. 3A, data transfer cradle 300 is adapted to accept medication management unit 100, particularly the serial port 135. Data cradle 300 is connected to the pharmacist's computer system 310. Pharmacist's computer system 310 is capable of running medication management desktop software (not shown) which interfaces with the pharmacist's standard software package, and facilitates the synchronization of data between the medication management unit 100 and pharmacist's computer system 310.

A cable 305 is used to connect the data transfer cradle 300 to the pharmacist's computer system 310. In one embodiment of the invention, the cable 305 is a standard serial cable connected to the COMM (serial) data port on the pharmacist's computer system 310. In another embodiment of the invention, the cable 305 is a Universal Serial Bus (USB) interface cable connected to the USB port or hub on the pharmacist's computer system 310.

Similarly, FIG. 3B shows a wireless interface between the medical management unit 100 and the pharmacist's computer system 310. Data may be transferred between the pharmacist's computer system 310 and the medical management unit 100 via a wireless communication means 330, such as for example electromagnetic waves. In one embodiment of the invention, the wireless communication means 330 may be in the form of radio frequency (RF) waves and the medication management unit 100 and pharmacist's computer system 310 are each equipped with a RF transceiver. In another embodiment of the invention, the wireless communication means 330 may in the form of Infrared (IR) waves, and the medication management unit 100 and pharmacist's computer system 310 are each equipped with an IR transceiver. In still a further embodiment of the invention, the wireless communication means 330 may be in the form of light waves. In such an embodiment, the medication management unit 100 is equipped with a sensor capable of reading light, typically in the form of bars of light. The monitor of the pharmacist's computer system flashes bars of light, representing the data being exchanged, which are read by the sensor on the medication management unit 100. The Data Link® system used by the Timex company is a representation of such a technology and is incorporated by reference herein.

Pharmacist's computer system 310 is capable of generating appropriate identification tags and/or labels, such as bar code labels 210 and RFID tag 215, through the use of peripheral devices that are well known in the art. In one embodiment of the invention, pharmacist's computer system 310 interfaces with a bar code printer 315 to print bar code labels 210. In another embodiment of the invention, pharmacist's computer system 310 interfaces with a RFID transceiver 320 to encode RFID tags with the medication's identification. In still another embodiment of the invention, pharmacist's computer system 310 interfaces with a contactless reader/writer 325 to encode the processor 220 affixed to vial 200 with the medication identification.

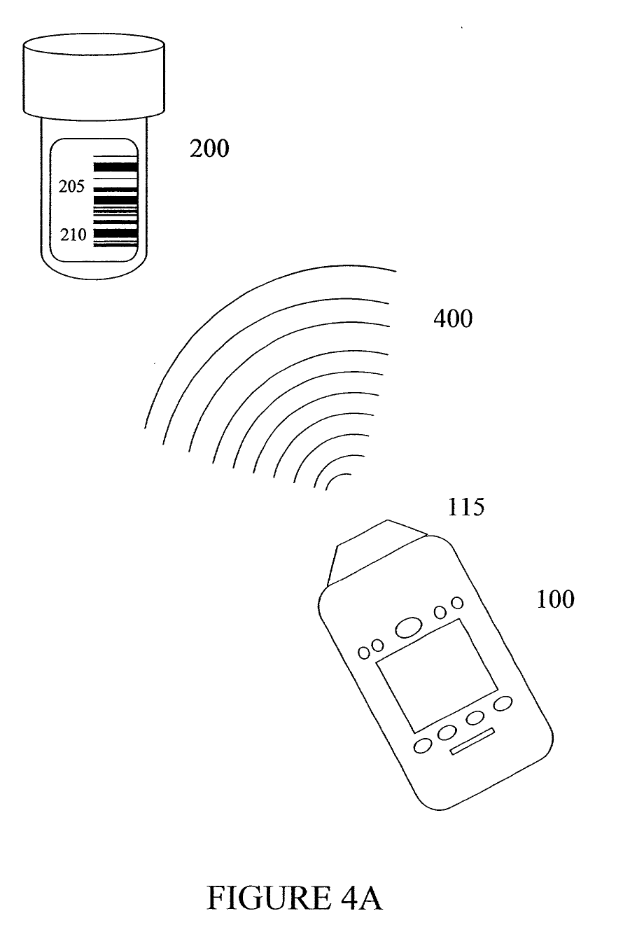

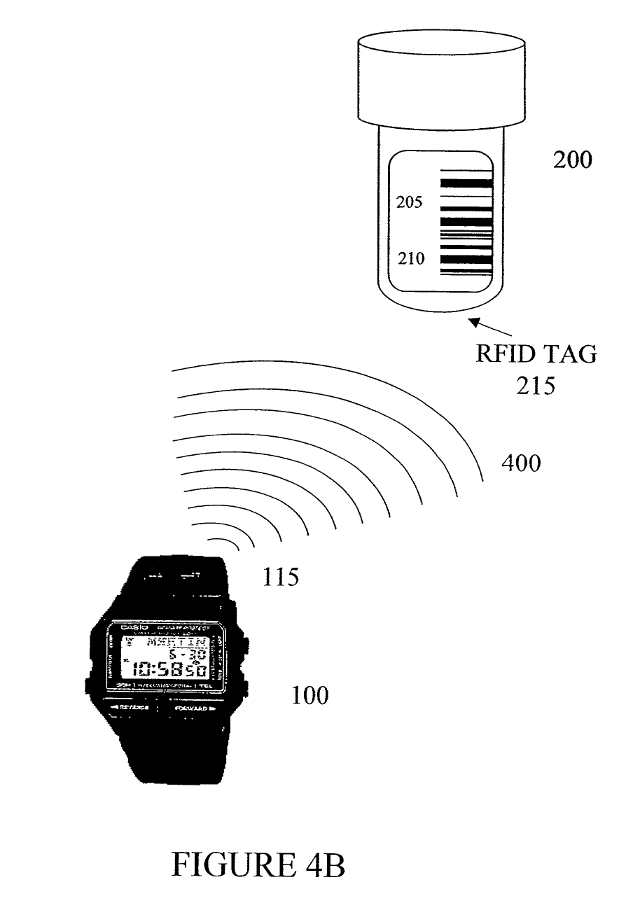

To determine whether the medication selected by the patient for administration is proper, the medication management unit 100 must first identify the medication. A diagrammatic representation showing the interrelationship of the system components according to an embodiment of the present invention is shown in FIG. 4A.

By way of example, upon being notified by medication management unit 100 to administer a medication, a patient selects medication vial 200. As previously explained, RX label 205 is affixed to medication vial 200 and identifies the medication. In addition, RX label 205 includes a bar code symbol 210 identifying, in graphical form, the medication and dosage.

The patient then takes medication management unit 100 equipped with I/O device 115 and scans the identification tag, i.e. bar code 210. In one embodiment of the invention, I/O device 115 is a visible laser diode (VLD) bar code scanner capable of reading bar codes and converting them to machine readable digital character code. I/O device 115 emits numerous laser beams 400 to capture the image of bar code 210 as reflected light. Photo diodes (not shown) integral to I/O device 115 convert the reflected light into electrical signals, which in turn are converted to digital pulses. The operation of a VLD bar code scanner is well known in the art.

In another embodiment of the invention, the I/O device 115 is an infrared scanner capable of reading bar codes and converting them to machine readable digital character code. I/O device 115 emits infrared electromagnetic waves 400 to capture the image of bard code 210 as reflected infrared radiation. An infrared sensor and processor in the medication management unit 100 reads the reflected infrared signals and converts them to digital pulses. The operation of a infrared bar code scanner is well known in the art.

The digital pulses created by the I/O device 115 are used by proprietary software (not shown) running in medication management unit 100 to identify the medication and determine if the correct medication has been selected by the patient. The medication management unit 100 then provides a notification to the patient indicating whether the correct medication has been selected. The notification may be aural, visual or both.

In one embodiment of the invention, a colored graphic in the form of a traffic light is displayed on display device 110. The colored graphic can illuminate a yellow, green or red indicator light to indicate whether the correct medication has been selected. In another embodiment of the invention, the medication management unit 100 has LED (light emitting diodes) indicator lights integrated within the unit that light to indicate whether the correct medication has been selected.

Similarly, FIG. 4B shows a diagrammatic representation illustrating the interrelationship of the system components according to another embodiment of the present invention. In one embodiment illustrated by FIG. 4B, the I/O device 115 is an electromagnetic transceiver capable of transmitting and receiving bands of electromagnetic radiation. This electromagnetic radiation may include invisible infrared transmissions as well as visible light and radio frequency (RF) transmissions. By way of example, if the I/O device 115 is a RF transceiver or “gun” capable of powering the electronic label or transponder (i.e. RFID tag 215) which contains identification information with regard to the medication. The I/O device 115 powers the RFID tag 215 and reads the identification of the information. This data is converted into a machine readable code. Proprietary software (not shown) running in medication management unit 100 uses this data to determine if the correct medication has been selected.

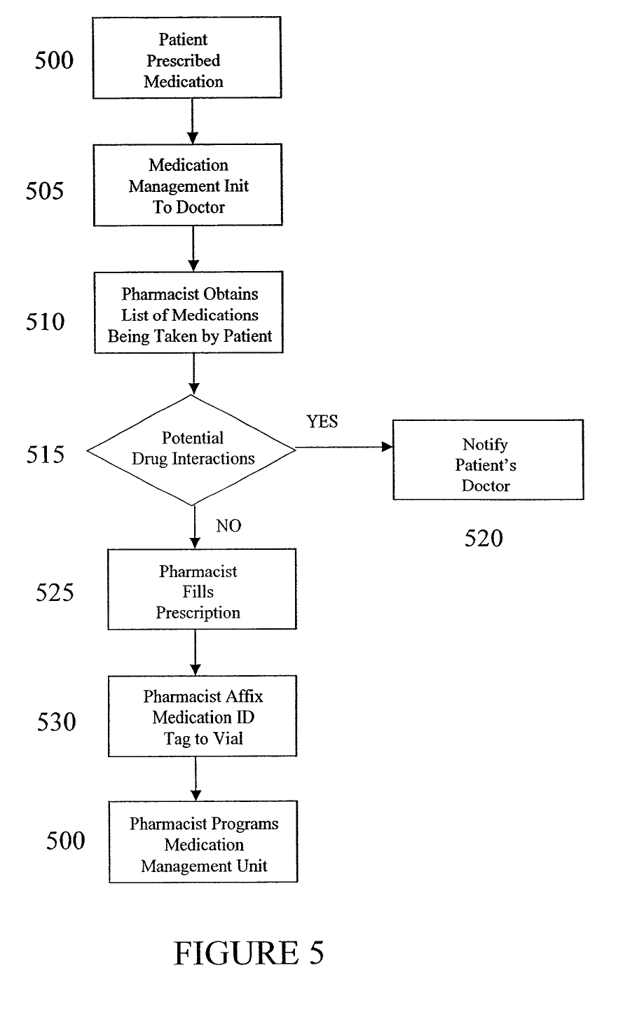

Turning now to FIG. 5, an illustrative flow diagram further depicting the steps to activate the medication management unit for use by a patient according to an embodiment of the present invention is shown. A preliminary step in activating the present system and method is the prescription of medication by a treating physician as shown in step 500. The patient then takes the prescription and medication management unit 100 to a participating pharmacist equipped to interface with the medication management unit 100.

In one embodiment of the invention, the patient may receive the medication management unit 100 from the treating physician. In another embodiment of the invention, the patient may receive the medication management unit 100 from the participating pharmacist. In still a further embodiment of the invention, the patient may receive the medication management unit 100 from a third party.

It is import to note that the medication management unit 100 is capable of tracking and storing the administration schedule for numerous different medications. In fact, a distinct benefit of the medication management unit 100 is the ability to store and track multiple medications being administered to or by the patient. Aside from organizing medication administration for the patient, this allows a doctor or pharmacist to download the patient's medication schedule, and determine what medications are being taken by the patient without relying on the patient's memory. This feature may become critically important to the physician or pharmacist when determining potential drug interactions, especially when the patient has been prescribed different medications by different doctors, or fills different medications at different pharmacies.

Accordingly, if a patient is already in possession of a medication management unit 100 as a result of previously being prescribed medication, they would present the medication management unit to the doctor during examination. This will afford the doctor an opportunity to download the patient's medication schedule, which may assist in patient evaluation. In addition, as previously mentioned, if the doctor sees a need to prescribe additional medication, the downloaded medication schedule will assist the doctor in determining potential drug interactions. Similarly, the pharmacist can download the patient's medication schedule and determine the patient's present medication routine when checking for drug interactions.

Once a medication is prescribed, the patient takes the medication management unit 100 and the prescription to a pharmacist as shown in step 505. In one embodiment of the invention, the doctor may provide the patient with a written prescription as typically provided today. In another embodiment of the invention, the doctor may provide the prescription to the patient in electronic form by programming the information into the medication management unit 100. In this embodiment, the , pharmacist may obtain the prescription by interfacing with the medication management unit 100 and downloading the prescription information.

The pharmacist receives the medication management unit 100 from the patient and interfaces the unit with the pharmacy computer system 310. The pharmacist then downloads the patient's medication schedule from the medication management unit 100 as shown in step 510. In one embodiment of the invention, the patient's newly written medication prescription, stored by the doctor in electronic format in medication management unit 100, is also downloaded by the pharmacist. In another embodiment of the invention, the patient provides the pharmacist with the doctor's written prescription, which is keyed into the pharmacist's computer system.

The pharmacist then examines the patient's present medication schedule and prescription for potential drug interactions as shown in step 515. Standard pharmaceutical texts and software packages for analyzing medications for potential drug interactions are well known in the art.

If a potential drug interaction is detected, the pharmacist will notify the patient's prescribing doctor as shown in step 520. If no potential drug interaction is detected, the pharmacist will fill the prescription as shown in step 525.

Once the prescription is filled, the pharmacist generates a medication identification tag, similar to bar code 210, RFID tag 215, or processor 220, and affixes the medication tag to vial 200 as indicated in step 530. The identification tag may be created using any compatible peripheral device, such as bar code printer 315, RFID transceiver 320 or contactless reader/writer 325.

The pharmacist then programs the patient's medication schedule into the medication management unit 100 as shown in step 535. In one embodiment of the invention, the pharmacist uses the medication management desktop software resident on the pharmacist's computer system 310 to update the patient's medication schedule database. The medication management unit 100 is then interfaced with the pharmacist's computer system 310 and the data between the two systems is synchronized. The programmed medication management unit 100 is then returned to the patient for use.

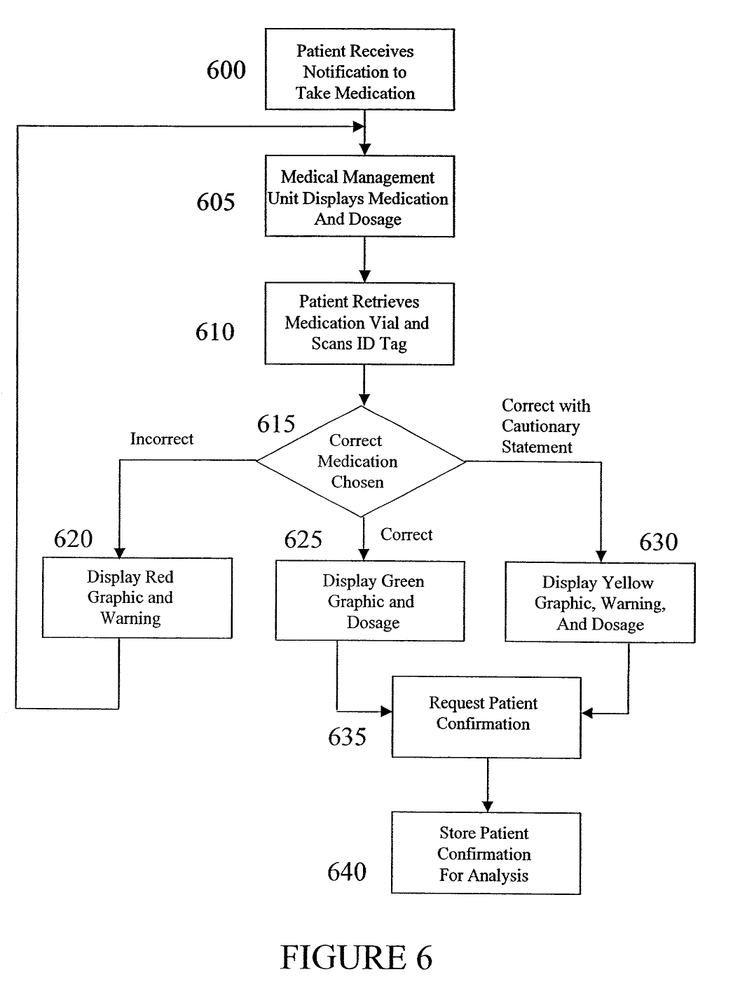

Once the programmed medication management unit 100 is returned to the patient it is ready for use. An illustrative flow diagram depicting the steps followed by a patient utilizing the programmed medication management system according to an embodiment of the present invention is shown in FIG. 6.

In step 600, the patient receives a notification from the medication management unit 100 to take a medication at a programmed period of time. As previously described, the notification to the patient may be aural, visual, vibratory or any combination of the three.

The medication management unit 100 then provides the patient with the identity of the particular medication and dosage to be administered as shown in step 605. As previously described, information describing what medication and dosage to administer can be communicated to the patient utilizing several different aural or visual methods, such as, for example, a textual message displayed on display 110.

Once the patient receives the information regarding the correct medication and dosage to self-administer, he or she retrieves the medication vial containing the proper medication and scans the identification tag associated with the selected medication. This identification tag may be the bar code 210 affixed to RX label 205, RFID tag 215 or processor 220. The medication management unit 100 then identifies the medication scanned by the patient and determines whether the patient has selected the correct medication for self-administration as shown in step 615.

In one embodiment of the invention, the medication management unit 100 uses bar code technology to identify the medication. In this embodiment, the bar code label 210 is encoded with the medication name and dosage requirements. When the medication management unit 100 identifies the scanned medication, software resident in the medication management unit 100 compares the scanned medication with the medication required to be administered in accordance with the programmed medication administration schedule.

Once a comparison is made between the scanned (patient selected) medication and the programmed medication, a determination is made as to whether the patient has selected and scanned the correct medication as shown in step 615. If a determination is made in step 615 that the scanned medication does not match the appropriate medication from the programmed medication administration schedule, the medication management unit 100 provides an appropriate notification to the patient as shown in step 620.

In one embodiment of the invention, the medication management unit 100 displays a red graphic on display 110 to indicate that the incorrect medication has been selected and scanned. In another embodiment of the invention, medication management unit 100 provides an audible warning that the incorrect medication has been selected and scanned. In still a further embodiment of the invention, the medication management unit provides a visual warning that the incorrect medication has been selected and scanned by displaying a textual message on display 110.

After a determination is made that the scanned medication is an incorrect choice, the medication management unit 100 once again displays the correct medication and dosage for administration as shown in step 605. The patient then repeats the process as previously described until the correct medication is found.

If a determination is made in step 615 that the scanned medication does match the appropriate medication from the programmed medication administration schedule, the medication management unit 100 provides an appropriate notification to the patient as shown in step 625.

In one embodiment of the invention, the medication management unit 100 displays a green graphic on display 110 to indicate that the correct medication has been selected and scanned. In another embodiment of the invention, medication management unit 100 provides an audible tone or textual message, as previously discussed, indicating to the patient that the correct medication has been selected and scanned.

In addition to providing notification to the patient that the correct medication has been selected and scanned, the medication management unit 100 is capable of providing cautionary statements to the patient regarding the administration of a medication. Cautionary statements may include, for example, warnings that the medication should be taken with meals or with milk, or that the medication may cause drowsiness. In addition, the cautionary warning may indicate the dosage requirements, for example, take 2 pills.

If a determination is made in step 615 that the patient has selected and scanned the correct medication, but a cautionary statement is associated with the medication, the medication management unit 100 provides an appropriate notification to the patient as shown in step 630.

In one embodiment of the invention, the medication management unit 100 displays a yellow graphic on display 110 to indicate that the correct medication has been selected and scanned, but that a-cautionary warning or notice is associated with the medication. In this embodiment, the cautionary warning is then provided to the patient in the form of a textual message displayed on display device 110.

In another embodiment of the invention, medication management unit 100 provides an audible tone or textual message, as previously discussed, indicating to the patient that the correct medication has been selected and scanned, but that a cautionary warning or notice is associated with the administration of the medication.

Once the correct medication has been selected, the medication management unit 100 requests the patient to confirm that the medication has been administered as shown in step 635. In one embodiment of the invention, the patient is requested to confirm administration of the medication by a textual message on the display 110. The patient can communicate the confirmation to the request by, for example, touching the appropriate area of the touch based display 110.

The medication management unit 100 then stores the patient's confirmation in memory resident within the unit as shown in step 640. In one embodiment of the invention, the confirmation is saved with a time and date stamp indicating the time the patient confirmed administration of the medication. A doctor treating the patient might use this information to ensure that the patient is maintaining the proper medication schedule, and assist in further treatment of the patient.

Although the present invention has been described in relation to particular preferred embodiments thereof, many variations and modifications and other uses may be made without departing from the invention. Accordingly, it is intended that all such alterations and modifications be included within the spirit and scope of the invention as defined in the appended claims.

1. A system for managing the administration of medication to a patient, the medication having a unique identity, the system comprising:
(a) an identification tag for identifying the medication selected to be administered to the patient; and
(b) a medication management unit, the medication management unit comprising a portable computing device and being capable of monitoring and assisting in maintaining compliance with a patient's medication administration schedule, the medication management unit further comprising;
(i) an application program;
(ii) timing device to monitor and determine a time for the administration of the patient's medication in accordance with the medication schedule;
(iii) a notification device for providing a notification that the medication needs to be administered;
(iv) a medication indicator for indicating the identity of the medication to be administered in accordance with the medication schedule;
(v) an I/O device for reading the medication identity from the identification tag associated a the selected medication;
(vi) a means for comparing the medication identity read from the identification tag to the medication identity from the medication indicator to determine if the correct medication was selected; and
(vii) a means for displaying the results of the comparison between the medication identity read from the identification tag and medication identity identified by the medication indicator.

2. The system of claim 1 wherein the identification tag is a bar code that stores the medication's identification.

3. The system of claim 1 wherein the identification tag is a RFID tag that stores the medication's identification in electronic format.

4. The system of claim 1 wherein the identification tag is a semiconductor chip that stores the medication's identification in electronic format.

5. The system of claim 1 wherein the portable computing device is a hand held computer.

6. The system of claim 1 wherein the portable computing device is a programmable wrist watch.

7. The system of claim 1 wherein the timing device determines the time for the administration of the patient's medication by monitoring actual calendar and clock time in real-time.

8. The system of claim 1 wherein the timing device determines the time for the administration of the patient's medication by measuring a time interval from the last time the medication was actually administered.

9. The system of claim 1 wherein the notification is aural.

10. The system of claim 1 wherein the notification is visual.

11. The system of claim 1 wherein the notification is vibratory.

12. The system of claim 1 wherein the medication indicator is a display device providing a textual message.

13. The system of claim 1 wherein the I/O device is a bar code scanner.

14. The system of claim 1 wherein the I/O device is an RFID reader capable of powering and reading a RFID identification tag using radio frequency signals.

15. The system of claim 1 wherein the I/O device is a contactless reader capable of reading information from a microprocessor using radio frequency signals.

16. The system of claim 1 wherein the I/O device is an infrared transceiver capable of reading and transmitting infrared signals.

17. The system of claim 1 wherein the means for comparing the medication identity read from the identification tag to the medication identity identified by the medication indicator comprises software resident in the medication management unit.

18. The system of claim 1 wherein the means for displaying the similarity between the compared medication identity from the identification tag and the medication identity identified by the medication indicator comprises a graphical representation on a display panel.

19. The system of claim 1 wherein the means for displaying the similarity between the compared medication identity from the identification tag and the medication identity identified by the medication indicator comprises an aural notification through a speaker system.

20. The system of claim 1 wherein the means for displaying the similarity between the compared medication identity from the identification tag and the medication identity identified by the medication indicator comprises a textual message displayed on a display device.

21. The system for managing the administration of medication to a patient of claim 1 further comprising an interface to a pharmacist's computer system.

22. The system of claim 21 wherein the interface comprises a data transfer cradle, electronically connected to the pharmacist's computer system, for receiving the medication management unit.

23. The system of claim 21 wherein the interface comprises an infrared transceiver operatively connected to the pharmacist's computer system, for communicating with the medication management unit through infrared signals.

24. The system of claim 21 wherein the interface comprises a light sensor operatively connected to the portable computing device for communicating with the pharmacist's computer system through light-wave signals.
